(19) United States
(12) Patent Application Publication
(10) Pub. No.: US 2026/0170517 A1
(43) Pub. Date: Jun. 18, 2026

(54) System And Method For Determining Email Inbox Placement By Comparison Of Engagement Between Senders

(71) Applicant: Derek Harding, Lake Forest Park, WA (US)

(72) Inventor: Derek Harding, Lake Forest Park, WA (US)

(21) Appl. No.: 19/415,129

(22) Filed: Dec. 10, 2025

Related U.S. Application Data
(60) Provisional application No. 63/733,103, filed on Dec. 12, 2024.

(51) Int. Cl. G06Q 30/0201

(52) U.S. Cl. CPC G06Q 30/02014

(57) ABSTRACT

A system and method compare individual email activity data between senders and from differences in observed activity determine if a specific sender's email is reaching a specific recipient's inbox or being directed into their spam folder.

### CLAIM OF PRIORITY

This application claims the benefit of U.S. Provisional Patent Application No. 63/733,103, filed on Dec. 12, 2024, entitled “System and Method for Determining Email Placement Using Engagement Metrics,” which is incorporated herein by reference in its entirety.

### FIELD OF THE INVENTION

The present invention relates to a mechanism to enable email marketers to predict if messages they send are going to the recipients' inboxes or ending up in their spam folder.

### BACKGROUND OF THE INVENTION

Email spam filtering systems sometimes route marketing and other email to the recipient's spam folder rather than their inbox. This typically causes the recipient not to see the message which reduces recipient response and engagement and harms the sender's reputation with the Inbox provider.

For these reasons being able to determine whether their messages are, or are not, reaching their recipients' inboxes is very important to marketers for measurement purposes and so they can take corrective action where necessary.

The email marketing industry currently uses seed addresses owned by a third-party provider to act as “canaries” indicating what proportion of the sender's email is reaching the inbox at any given provider. Seeds only provide provider-level, indicative signals. These can only be used with batch sending and with changes in filtering they are losing accuracy.

Accordingly, a need exists for more accurate prediction techniques to determine if emails are being directed to inboxes rather than to spam folders.

### SUMMARY OF THE INVENTION

It is an object of many embodiments of the present invention to predict whether an email is directed to a recipient's inbox rather than to a spam folder.

It is an object of many embodiments of the present invention to identify whether an email is directed to a recipient's inbox rather than to a spam folder.

By analyzing engagement events for individual recipients between different senders and comparing the pattern of engagement the disposition of a sender's email to a specific subscriber can be determined.

Preferred embodiments identify signals that indicate an email reached a subscriber's inbox, including machine-generated open events. The systems and method then identify subscribers that are generating such events for some senders but not for the sender whose placement is being determined. Once sufficient expected events have not been seen it is determined that the sender's email is not reaching the subscriber's inbox, and is likely being sent to a spam folder.

### BRIEF DESCRIPTION OF THE DRAWINGS

In the following detailed description the teachings of the present application will be explained in more detail with reference to the example embodiments shown in the drawings, in which:

FIG. 1 is a flow chart showing a high-level conceptual diagram of the primary procedure of a preferred embodiment.

FIG. 2 is a flow chart illustrating more detail and steps to ingest, store and analyze activity data and client subscriber lists of the preferred embodiment.

FIG. 3 is a flow chart showing more detail of a portion of the preferred embodiment showing the data normalization, classification and storage process.

FIG. 4 is a flow chart showing more detail of a portion of the preferred embodiment showing an exemplary inbox placement user interface model for batch analysis of subscriber lists.

### DETAILED DESCRIPTION OF THE PREFERRED EMBODIMENT

In the following detailed description, the system and method for inbox placement classification will be described for the embodiment of email inbox placement identification with exemplary embodiments of a web and api (application programming interface) interface.

The core teaching of many embodiments of the system 100, as illustrated in FIG. 1 is determination at step 102 of email disposition or classification (inbox or spam folder placement) at step 104 by comparison of individual event behavior in response to one sender at step 101 to the same individual's event behavior from other senders at step 103.

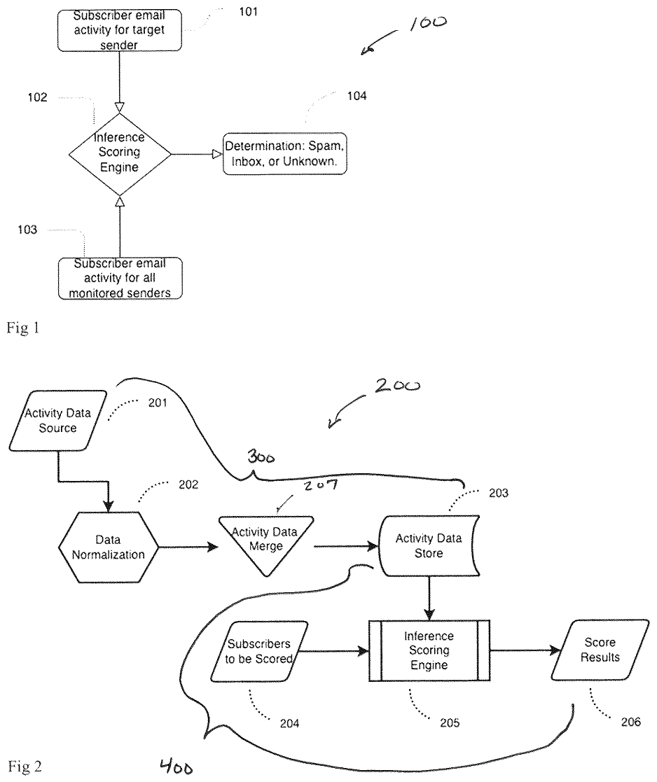

FIG. 2 illustrates a more detailed embodiment of a portion of the system 100 as system 200 whereby engagement and event data at step 201 are received from messaging platforms and multiple classification layers at step 202 are applied to normalize and accurately classify the data. These data are then stored at step 203 such that a scoring engine at step 205 can efficiently retrieve and score the disposition at step 206 for selected emails of selected individuals at step 204.

At least the preferred embodiment accepts at least some, if not all, of the following events at step 201: Send, Open (possibly classified as machine or human open), Click (possibly classified as machine or human click), Bounce (possibly classified as hard or soft), Unsubscribe, and/or Complaint.

Ingestion of data in an accumulator at step 201 is supported through a variety of methods including, but not limited to, machine to machine API pull, machine to machine webhook notification, secure FTP (File Transfer Protocol) upload, secure FTP download, and cloud to cloud data transfer. Ingestion at step 201 preferably occurs at a processor, such at a remote processing/storage location in the cloud, but other locations and systems could be implemented with other embodiments.

With the data acquired at step 201, the data is normalized or analyzed at step 202 and merged with other acquired data from step 201 at merge step 207 to be stored in computer memory at step 203.

Then, when a user, such as a subscriber has an email needing to be scored at step 204, a prediction engine such as an interference score engine at step 205 can access the activity data stored at step 203 and apply an algorithm with a processor to ascertain whether the subscriber's email has likely made it to the inbox of a recipient, or been directed to a spam folder at step 206.

A simplified version of the inference algorithm at step 205 does the following for many embodiments: looks up all the data for a given address, determines if there are recent send events to this user from sender 1, if not it returns unknown, determines if there is a recent (configurable limit) inbox event for sender 1, if so it returns inbox, determines if there are sufficient (configurable limit) recent send events from other senders, if not it returns unknown, determines if there are recent (configurable limit) inbox events for those other senders, if so returns spam. More complex algorithms may be employed with other embodiments.

The result is that email is determined by the algorithm for many embodiments going to the spam folder if: sender 1 has sent email to the email address and (a) there have been no inbox events for sender 1 but (b) other senders have also sent email to the email address and (c) other senders have seen inbox events. The outcome confidence increases as the amount of time that has passed since an expected event should have occurred increases and as the number of expected events that should have occurred increases.

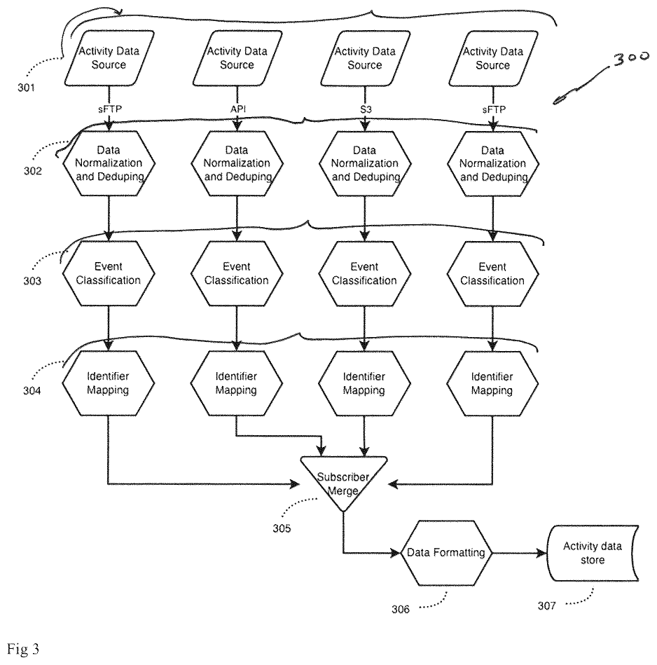

FIG. 3 shows an exemplary embodiment of the ingestion process 300 shown in FIG. 2 whereby data is received from a number of sources through multiple transfer mechanisms 301 such any or all of as secure FTP upload or download, Application Programming Interface, simple storage service (S3) transfer, or other data sources at step 301.

The incoming data is then normalized at step 302, such as by standardizing timestamps, identifying and removing duplicates, etc . . . At step 303 events are classified. At step 304 identifiers are mapped. The treated data is then merged at step 305 formatted at step 305 and stored in the activity data store at step 306.

The classification process at step 303 distinguishes automated open events from those caused by individual recipients actually reading email. This may be achieved through a detailed analysis of the open data and the patterns therein including timing, quantity, source, event-specific attributes by applying an algorithm to the data.

Events are merged at step 304 and stored by subscriber at step 305 with each subscriber preferably pseudonymously identified and each sender preferably anonymously identified for many embodiments.

To facilitate analysis while maintaining subscriber privacy, activity data is preferably stored in a highly compressed, pseudonymized, and encrypted form at step 307 for many embodiments.

The inbox placement inference engine retrieves the data for the subscriber in question at step 301 and applies comparative behavioral analysis of events at steps 303/305 between senders to determine inbox placement for a given sender. This analysis may use human open and click events to indicate inbox placement; and missing expected machine opens to indicate spam placement for at least some embodiments. Bounce, unsubscribe and complaint events make inbox placement irrelevant as no further email should be sent and will likely not be received and that information can be provided to be stored at step 307 for at least some embodiments. An algorithm is implemented using the email source provider for the recipient, observed behavior of the recipient for emails sent by other senders including whether the recipient opened the email (manually rather than automatically as could occur under some scenarios which could be product/service dependent).

A missing, expected, machine open is where an email has been sent to a subscriber that continues to show machine opens for other senders but after sufficient time has elapsed no machine open has been seen for the sender in question. Sufficient time elapsed could be at least seven days or a statistically significant sample period. The algorithm can take such information into consideration.

Also, the amount of data possessed by the system can assist in providing more predictive outcomes. It is estimated that the applicant has access to at least ⅓ of the emails sent worldwide through various sources thereby providing extremely good likelihood of opening data using their algorithm.

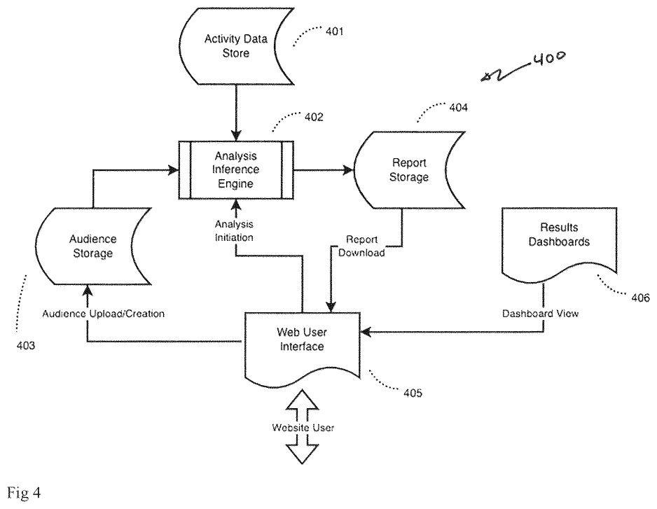

An exemplary embodiment of a batch reporting and output layer 400 is shown in FIG. 4 such that customers can use a web interface at step 405, or other interface, to upload subscriber lists, or at least one email address to be tested at step 403; create and run analyses at step 402; download the results at step 404; and view dashboards at step 406 showing inbox placement rates overall and by provider or otherwise employ a communication tool to output results to the User.

Another exemplary embodiment is an API, which is not a web service as illustrated, although some APIs can be run as web based services, whereby a customer may directly request the current inbox disposition of an email addresses of one or more subscribers.

In order to somewhat accurately describe the method, a method 100,200 of determining the likelihood of an email being directed from a first sender to an inbox of a user rather than a spam folder comprises the steps of: a) accumulating data related to emails of a first email address from at least a second sender other than the first sender 103, 201, 301; b) possibly storing the data related to the first email address from the at least the second sender 203,401; c) predicting whether the mail from the first sender would arrive in the inbox of the user using a prediction algorithm for the first email address 102,205,402; and d) advising the first sender of the likelihood of the email of at least one of (a) being sent to the inbox of the user, (b) being sent to a spam filter of the user, and (c) directed to an unknown location of the user 104, 206, 404, 406 (i.e., the processor cannot determine whether it made it to the User's inbox, spam folder or other location).

The methodology described above may be systematized and described as an apparatus for determining the likelihood of an email being directed to an inbox at an email address comprising: an accumulator which receives data related to emails of a first email address of a user from at least a second sender other than the first sender; an analyzer applying a prediction algorithm to the data related to the first email address from the at least the second sender; a prediction engine determining whether the mail from the first sender arrived in the inbox of the user using the prediction algorithm for the first email address; and a communication tool advising the first sender of the likelihood of the email of at least one of (a) being sent to the inbox of the user, (b) being sent to a spam filter of the user, and (c) directed to an unknown location of the user. The methodology and/or system could also be described in terms of a non-transitory computer-readable medium for predicting receipt of an email in an inbox of a user a computer, comprising instructions stored thereon, that when executed on a processor, perform the steps of: accumulating data in a computer related to emails of a first email address of a user from at least a second sender other than the first sender in computer memory; analyzing the data at the computer related to the first email address from the at least the second sender through a prediction algorithm; predicting whether the mail from the first sender would arrive in the inbox of the user using the prediction algorithm for the first email address with a processor; and advising the first sender remotely from the computer of the likelihood of the email of at least one of (a) being sent to the inbox of the user, (b) being sent to a spam filter of the user, and (c) directed to an unknown location of the user. All of the limitations described above relative to the method also apply to the system and/or non-transitory computer-readable medium.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A method of determining the likelihood of an email being directed from a first sender to an inbox of a user rather than a spam folder of the user comprising the steps of:
a) accumulating data related to emails of a first email address of a user from at least a second sender other than the first sender;
b) analyzing the data related to the first email address from the at least the second sender through a prediction algorithm;
c) predicting whether the mail from the first sender would arrive in the inbox of the user using the prediction algorithm for the first email address; and
d) advising the first sender of the likelihood of the email of at least one of (a) being sent to the inbox of the user, (b) being sent to a spam filter of the user, and (c) directed to an unknown location of the user.

2. The method of step 1 further comprising the step of storing the data related to the first email address from the at least the second sender.

3. The method of step 2 wherein the steps of accumulating and analyzing data related to the first email address further comprising accumulating and analyzing data from multiple second senders.

4. The method of step 1 wherein the steps of accumulating and analyzing data related to the first email address further comprising accumulating and analyzing data from multiple second senders.

5. The method of claim 1 wherein data related to the first email address is obtained through at least one of secure file transfer protocol and application programming interface at step (a).

6. The method of claim 5 wherein after data is obtained at step (a), data is normalized and events are classified.

7. The method of claim 6 wherein after events are classified, identifiers are mapped and then data is merged before analyzing relative to the first email address to be used by the first sender.

8. The method of claim 7 wherein after merging the data, the data is formatted, and then stored before analyzing relative to the first email address to be used by the first sender.

9. The method of claim 2 wherein the analysis step is performed at an analysis inference engine.

10. The method of claim 2 wherein the first sender accesses the analysis inference engine through at least one of an API and a web user interface providing at least the first email address for analysis.

11. The method of claim 10 wherein the prediction step outputs a report which is provided to the first sender in the advising step.

12. The method of claim 11 wherein the report is stored in report storage.

13. The method of claim 11 wherein the report is displayed on a results dashboard to the first sender.

14. The method of claim 1 wherein the prediction is based at least partially on how the first email address is received by the second sender.

15. An apparatus for determining the likelihood of an email being directed to an inbox at an email address comprising:
an accumulator which receives data related to emails of a first email address of a user from at least a second sender other than the first sender;
an analyzer applying a prediction algorithm to the data related to the first email address from the at least the second sender;
a prediction engine determining whether the mail from the first sender arrived in the inbox of the user using the prediction algorithm for the first email address; and
a communication tool advising the first sender of the likelihood of the email of at least one of (a) being sent to the inbox of the user, (b) being sent to a spam filter of the user, and (c) directed to an unknown location of the user.

16. A non-transitory computer-readable medium for predicting receipt of an email in an inbox of a user a computer, comprising instructions stored thereon, that when executed on a processor, perform the steps of:
a) accumulating data in a computer related to emails of a first email address of a user from at least a second sender other than the first sender in computer memory;
b) analyzing the data at the computer related to the first email address from the at least the second sender through a prediction algorithm;
c) predicting whether the mail from the first sender would arrive in the inbox of the user using the prediction algorithm for the first email address with a processor; and
d) advising the first sender remotely from the computer of the likelihood of the email of at least one of (a) being sent to the inbox of the user, (b) being sent to a spam filter of the user, and (c) directed to an unknown location of the user.
